(19) United States
(12) Patent Application Publication
(10) Pub. No.: US 2009/0245249 A1
(43) Pub. Date: Oct. 1, 2009

(54) MULTICAST NODE APPARATUS, MULTICAST TRANSFER METHOD AND PROGRAM

(75) Inventors: Kazuya Suzuki, Tokyo (JP); Masahiro Jibiki, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/064,838

(22) PCT Filed: Aug. 25, 2006
(86) PCT No.: PCT/JP2006/316674

§ 371 Date: Feb. 26, 2008

(30) Foreign Application Priority Data
Aug. 29, 2005 (JP) 2005-248263

(51) Int. Cl. H04L 12/56

(52) U.S. Cl. 370/390

(57) ABSTRACT

To provide an apparatus that optimizes the wait time in node apparatuses performing a packet backup using a multipath. The apparatus uses statistic information related to the transmission qualities of the paths constituting the multipath, thereby determining the minimum wait time that satisfies a target packet backup rate.

### APPLICABLE FIELD IN THE INDUSTRY

The present invention relates to a multicast node apparatus, a method of backing up a lost packet that is used for it, and a program thereof, and more particularly to an apparatus, a method, and a program that allow a wait time at the time of backing up the lost packet to be optimized in performing redundant delivery of the packet employing a multipath.

### BACKGROUND ART

With a diffusion of broadband networks, the high-quality video delivery service, which was difficult in a conventional narrowband network, is being realized. Further, employing a multicast technology for delivering a video packet makes it possible to delivery the video packet to a large number of users while saving a server or a band of the network. The multicast transfer technology in an IP (Internet Protocol) layer, however, has the following problems.

The first problem lies in a point that employing an IP multicast transfer requires that all routers existing in a delivery path be correspondent to an IP multicast (see FIG. 1). Reproduction of the multicast packet in a diverging point needs to be performed in the IP layer, whereby the router, which performs the process of the IP layer, has to perform it. In FIG. 1, the router, which performs the process of the IP layer, reproduces the multicast packet in nodes 12, 13, 14, 15, 16, and 17 of the diverging points.

The router apparatus, which is widely being used at present, is not correspondent to the IP multicast in many cases due to issues such as architecture and software.

The second problem lies in a point that there is a possibility of exerting a baneful influence upon other communication in a case where a loop occurs because the reproduction of the packet is repeated in the IP multicast network that has not been correctly set, thereby wasting the network band or resource of the router.

In consideration of such an operational reason, also in the network employing the router that corresponds to the multicast, the setting is made so that its function (multicast) is not used in may cases. For this, in launching the use of the IP multicast over the existing network,
the IP multicast non-correspondence router has to be replaced with the correspondence router, or
in a case where the existing router is correspondent to the IP multicast, the appropriate setting has to be made for the IP multicast function, which has been set so that its function is not used, in order to prevent problems from occurring.

The application-level multicast technique has been proposed so as to avoid theses problems (see FIG. 2). In this technique, the reproduction of the packet, which was performed in the IP layer, is performed in an application layer. In FIG. 2, in the nodes 12, 13, 14, 15, 16, and 17 of the diverging points, the reproduction of the packet is performed in the application layer higher than the IP layer (the diverging nodes having a two-stage configuration are shown).

This technique can be used also in the conventional IP multicast non-correspondence network because an IP-layer unicast packet is used for communication between the application-level multicast node apparatuses.

The real time video delivery employing the IP network has the problems such as
a fluctuation in an arrival interval of the packet, and
a packet loss.

As a rule, a streaming server, which delivers the video, sends out the packet according to the reproduction interval of the video. Assuming that a transmission delay in the network is constant, it is enough that a receiving terminal reproduces the received packet as it stands. However, the transmission delay in the network is not constant, and dispersion occurs. So as to absorb this dispersion (fluctuation) in the delay, the receiving terminal performs the buffering for the received packet for a constant time, thereby to absorb an influence caused by the dispersion. At this moment, the video is not reproduced immediately after receiving the packet, but the value obtained by adding the wait time having a transmission delay taken into consideration on the basis of a timestamp that the streaming server has affixed packet by packet at the time of the delivery is used as a timing at which the video is reproduced. This enables the reproduction of the video in the reception side to be performed at a timing identical to the timing at which the streaming server sends out the packet without being influenced by the dispersion in the transmission delay in the network.

In the IP network, a loss of the packet occurs due to various factors such as a burden of the router and a congestion of the network. A loss of the packet leads to deterioration in a reproduction quality of the video caused by omission of a frame.

The technique of Forward Error Correction employing a corrective encoding technology has been proposed for coping with this problem. This technique is a technique of redundantly pre-transmitting the packets and backing up the lost packets.

However, employing this technique arouses the following problems.

In this technique, the band of the network is excessively used because the redundant packets have to be sent out, which could raise a loss rate of the packet all the more. It is possible to restore the packets, which are lost isolatedly, at a high provability; however, the packet cannot be restored in many cases in a situation where the packets are continuously lost.

Such a situation occurs due to disconnection of a link, a failure of a relaying apparatus, or the like in the IP layer or the lower layer, and thus, it becomes impossible to cope with the packet loss only by means of the technology of the FEC under such a situation.

It is thinkable that exclusive paths that do not share the link or the node are prepared in plural for the continuous loss of the packets, and an identical packet is sent out redundantly to respective paths.

However, as a rule, a manger cannot explicitly decide the delivery path in the IP layer. Assuming that the packets are sent out redundantly, it follows that the packets pass through the identical path, so it is difficult to prevent the continuous loss. For this, this technique cannot be employed in the general IP multicast.

On the other hand, the path in communication between the nodes cannot be explicitly decided in an application-level multicast similarly to the IP multicast; however the manger can decide the node through which the packet passes.

For this, appropriately arranging the application-level multicast nodes in the network, and successively selecting the node through which the packet passes so that the link or the node through which the packet passes is not shared makes it possible to constitute an exclusive path.

An example of the multipath in the application-level multicast is shown in FIG. 3. One of the paths from a transmitter 31 to receivers 41 and 42 is comprised of nodes 11, 12, 22, 23, 13, and 14, and the other is comprised of nodes 11, 12, 16, 15, and 14, whereby the exclusive multipath is configured so that the link or the node through which the packet passes is not shared. On the other hand, in the multicast of FIG. 2, each of paths from a transmitter 31 to receivers 41 and 42 is regarded identical to the other in the nodes 11, 12, 22, 23, and 13.

Additionally, in a Patent document 1 are disclosed the method, the system, and the terminal apparatus for allowing delivery video to be simultaneously reproduced by forwarding a multicast packet including media data and information indicative of a delivery time from a video delivery server to each terminal apparatus, receiving the multicast packet in each terminal apparatus, collecting information of the delivery time and the reception time in a certain terminal, computing, for example, a maximum delivery delay time, and subtracting the delay time in each terminal apparatus from this maximum delivery delay time, thereby to obtain a wait time, which ranges from reception up to reproduction of the media data, in its own terminal apparatus.

Patent document 1: JP-P2003-235027A

### DISCLOSURE OF THE INVENTION

### Problems to be Solved by the Invention

As mentioned above, the conventional multicast system has the points at issue described below.

The first point at issue is that it is difficult to decide an appropriate wait time in a case of utilizing the technology of backing up the packet by the multipath.

Herein, the so-called wait time is equivalent to a value obtained by subtracting the clock time at which the packet is sent out from the transmission source from the clock time at which the packet is sent out from the node apparatus (see, for example, 66 of FIG. 4). And, that the wait time is long signifies that a buffering time for each packet is lengthened, and the quantity of the packet staying within the node apparatus is enlarged in that degree.

Further, that the buffering time in the node apparatus is long signifies that a delay as well in the arrival of the packet is enlarged. For this reason, the wait time is desirably shortened as much as possible.

Regrettably, dispersion in the delays in respective paths could not be absorbed in a case where the wait time is short.

The transmission delay of the packet is not constant, and the dispersion occurs in the IP network. For this, with the multipath, when the packet lost in the path of which a delay is smaller has to be backed up by using the other path, there is the possibility that the packet does not arrive during the wait time due to an increase in the delay of the latter path. Hereinafter, explanation thereof will be made, based upon an investigation result by this inventor.

A timing diagram of FIG. 4 is employed for explanation. Additionally, FIG. 4 is a diagram prepared by this inventor for a purpose of explaining the problem. In FIG. 4, 51 indicates a timeline of the packet in the transmission source, and the traverse axis signifies a lapse of the time. In the protocol aiming at a real time transfer, for example, a RTP (Real-time Transport Protocol), respective sequence numbers are affixed to the packets in the transmission source, which are sent out. Herein, it is assumed that sequence numbers 617, 618 and 619 are affixed to packets 11, 12, and 13, respectively. In FIGS. 4, 52 and 53 signify a timeline at the time that these packets have arrived at the node apparatus, being a junction, via a path 1 and a path 2, respectively, which constitute a multipath. It is assumed that the packet 11 having the sequence number 617 has arrived at the node apparatus via the path 1, and has arrived at the node apparatus via the path 2, respectively, after the mean delay times of respective paths elapsed since the transmission source sent out it.

A packet 21 having arrived at the node apparatus via the path 1 is sent out with the value obtained by adding a wait time 66 to the timestamp, which is included in the packet, assumed to be a sending-out time (packet 41). Herein, a so-called buffering time 65 of the packet 21 in the path 1 is a value obtained by subtracting a transmission delay of the packet 21 (this time, it is a mean delay 62) from the wait time 66.

A packet 31 having arrived via the path 2 is sent out as the packet 41 instead of the packet 21 in a case where the packet 21, which is to arrive via the path 1, has been lost in the path, and has not arrived.

In an example of FIG. 4, the packet 31 is cancelled after it is received because the packet 21 has arrived at the node apparatus without being lost. The packet 11 having the sequence number 617 has arrived at the node apparatus by a transmission delay of the mean delay time of each path via respective paths; however, as a rule, the packet arrives at the node apparatus behind schedule because a transmission delay 67 exceeding the mean delay time occurs in some cases (packet 22), and arrives at the node apparatus by a transmission delay 68 falling below the mean delay time in some cases (packet 32) like the case of the packet 12 that is sent out with the sequence number 618 affixed hereto.

Now think about the case that the packet 13 having the sequence number 619 sent out from the transmission source has been lost in the path 1. In this case, the packet is backed up by sending out the packet 33 having the sequence number 619, which is to arrive via the path 2, instead of the packet 23. However, as shown in FIG. 4, the packet cannot be backed up in a case where the packet 33 has arrived by a delay larger than the wait time because the transmission time of the packet 43 has been expired.

Shortening the wait time in such a manner raises the possibility that the packet cannot be backed up.

Thus, an object of the present invention is to provide an apparatus, a method, and a program that enable a minimum wait time to be obtained while a target packet backup rate is satisfied, and yet are preferredly employed for a node apparatus for backing up the packet using a multipath.

### Means to Solve the Problems

As a means to solve the foregoing problems, a node apparatus relating to a first aspect of the present invention includes:

a network interface that makes a connection to an network existing outside the apparatus;

a packet receiver for receiving a packet including a sequence number and a timestamp via the network interface;

a packet synchronizer for making a reference to the sequence number of the received packet, and filing only the packet having a not-filed sequence number into a transmitting buffer;

a statistics processing unit for collecting statistic information relating to a delay reception path by reception path from the received packet; and

a wait time calculator for deciding a wait time of the packet based upon the statistic information collected by the statistics processing unit.

In the present invention, the statistics processing unit obtains a mean of the delays of the packets. The statistics processing unit obtains a variance of the delays of the packets.

A backup rate of the packet is governed by two elements, i.e. a loss rate of the packet for each path in the network and a rate at which the packet arrives within the wait time. The wait time calculator prepares an arrival rate table indicative of a relation between the wait time and the arrival rate based upon a probability distribution function that is obtained from a mean and a variance of the transmission delays for each path obtained in the statistics processing unit of the present invention, and a pre-given loss rate for each path. In accordance with the present invention, a minimum wait time that satisfies a target packet backup rate (arrival rate) is obtained by employing, for example, the arrival rate table.

The node apparatus relating to another aspect of the present invention includes an arrival rate measure, thereby enabling the arrival rate (and the loss rate) of the packet to be obtained path by path in the actual network. Also in a situation where the arrival rate of the packet fluctuates, this makes it possible to obtain an appropriate wait time responding to its situation during operation of this apparatus.

The method relating to another aspect of the present invention, which is a multicast packet transfer method of receiving a packet including a sequence number and a timestamp, making a reference to the sequence number of the received packet, and sending out the packet having a not-sent sequence number at a sending-out time, includes the steps of:

collecting statistic information relating to a delay value reception path by reception path from the received packet; and

computing a wait time of the packet based upon the collected statistic information.

In the method relating to the present invention, a mean of the delays of the packets is obtained in the step of collecting the statistic information.

In the method relating to the present invention, a variance of the delays of the packets is obtained in the step of collecting the statistic information.

In the method relating to the present invention, the step of computing the wait time is a step of deciding the wait time for each reception path of the packet by employing a probability distribution function.

In the method relating to the present invention, the step of computing the wait time is a step of deciding the wait time by employing a frequency distribution relating to the delay of the packet.

In the method relating to the present invention, which further includes a step of measuring an arrival rate of the packet, the step of computing the wait time is a step of deciding the wait time by employing the measured arrival rate.

The computer program relating to another aspect of the present invention is comprised of programs for causing a computer to execute the processes of:

receiving a packet including a sequence number and a timestamp in performing a multicast transfer;

making a reference to the sequence number of the received packet, and sending out the packet having a not-sent sequence number at a sending-out time;

collecting statistic information relating to a delay value reception path by reception path from the received packet; and

computing a wait time of the packet based upon the collected statistic information.

In the computer program relating to the present invention, the process of collecting the statistic information includes a process of obtaining a mean of the delays of the packets.

In the computer program relating to the present invention, the process of collecting the statistic information includes a process of obtaining a variance of the delays of the packets.

In the computer program relating to the present invention, the process of computing the wait time includes a process of deciding the wait time by employing a probability distribution function for each reception path of the packet.

In the computer program relating to the present invention, the process of computing the wait time includes a process of deciding the wait time by employing a frequency distribution relating to the delay of the packet.

The computer program relating to the present invention is comprised of programs for causing the computer to execute the processes of:

measuring an arrival rate of the packet; and

deciding the wait time by employing the measured arrival rate.

### AN ADVANTAGEOUS EFFECT OF THE INVENTION

The first effect of the present invention lies in a point that a memory quantity that is used in the buffering of the node apparatus can be minimized while a target packet backup rate is satisfied. Lessening the memory quantity necessary for the buffering makes it possible to suppress a cost of the node apparatus because the quantity of the memory that is installed into the node apparatus can be lessened. Further, employing the technique of the present invention makes it possible to treat much more stream delivery even though the quantity of the memory that is installed is identical.

The second effect of the present invention lies in a point that an accumulated delay in the packet transmission can be minimized while a target packet backup rate is satisfied. The buffering for backing up the packet is necessitated in the node apparatus that exists in a junction of the multipath, and inevitably, delay equivalent to its buffering time occurs. Further, a delay occurs to a certain extent until transmission of the received packet is finished completely in the application-level multicast node apparatus other than the node apparatus that exists in a junction of the multipath. Employing the technique of the present invention makes it possible to suppress a delay in a junction of the multipath at a minimum level.

### BRIEF DESCRIPTION OF THE DRAWINGS

FIG. 1 is a network view illustrating a packet transfer by the IP multicast.

FIG. 2 is a network view illustrating a packet transfer by the application-level multicast.

FIG. 3 is a network view illustrating a multipath packet backup by the application-level multicast.

FIG. 4 is a timeline view illustrating a multipath packet backup.

FIG. 5 is a block diagram illustrating a configuration of the node apparatus of a first embodiment of the present invention.

FIG. 6 is a view illustrating a configuration of an upstream pier management table in the first embodiment of the present invention.

FIG. 7 is a view illustrating a configuration of a path table in the first embodiment of the present invention.

FIG. 8 is a view illustrating a configuration of a downstream pier management table in the first embodiment of the present invention.

FIG. 9 is a flowchart illustrating the process of computing a mean and a variance of the delays of each path in the first embodiment of the present invention.

FIG. 10 is a flowchart illustrating the process of deciding the wait time in the first embodiment of the present invention.

FIG. 11 is a view illustrating a configuration of an arrival rate table in the first embodiment of the present invention.

FIG. 12 is a flowchart illustrating the process of synchronizing the packet in the first embodiment of the present invention.

FIG. 13 is a block diagram illustrating a configuration of the node apparatus of a second embodiment of the present invention.

FIG. 14 is a block diagram illustrating a configuration of the node apparatus of a third embodiment of the present invention.

FIG. 15 is a view illustrating a configuration of a frequency distribution table in the third embodiment of the present invention.

FIG. 16 is a view illustrating a configuration of an accumulated frequency distribution table in the third embodiment of the present invention.

FIG. 17 is a flowchart illustrating the process of deciding an arrival rate table in the third embodiment of the present invention.

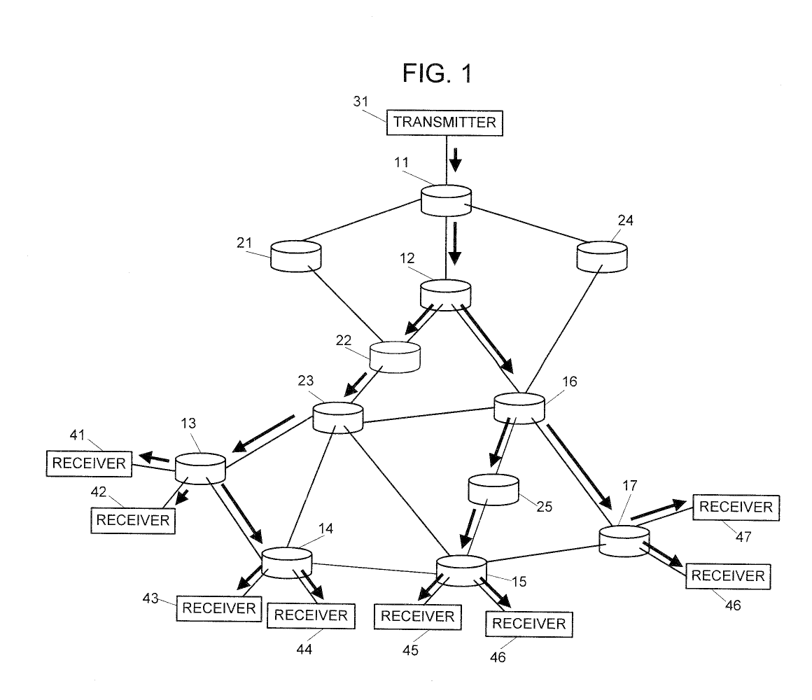

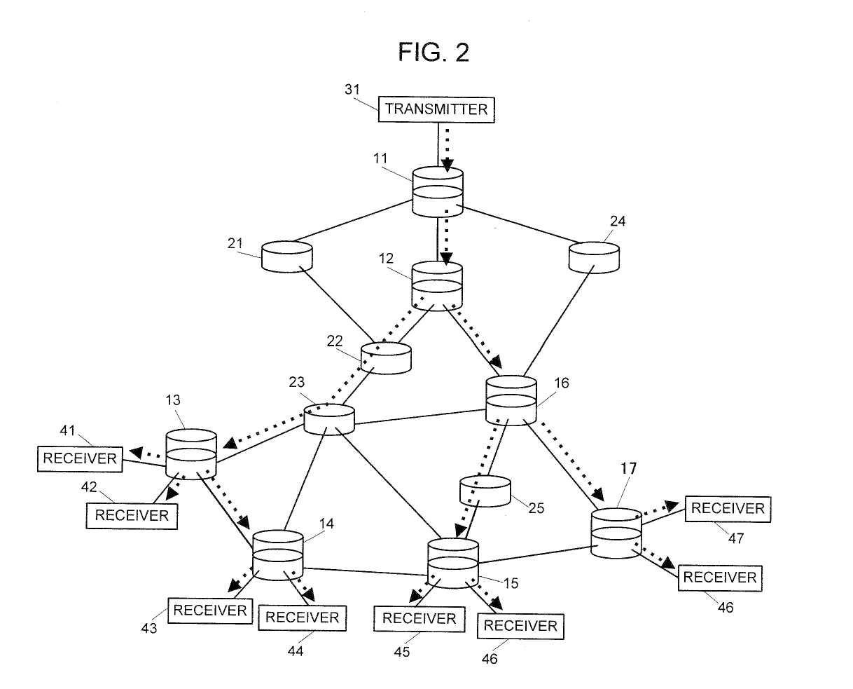

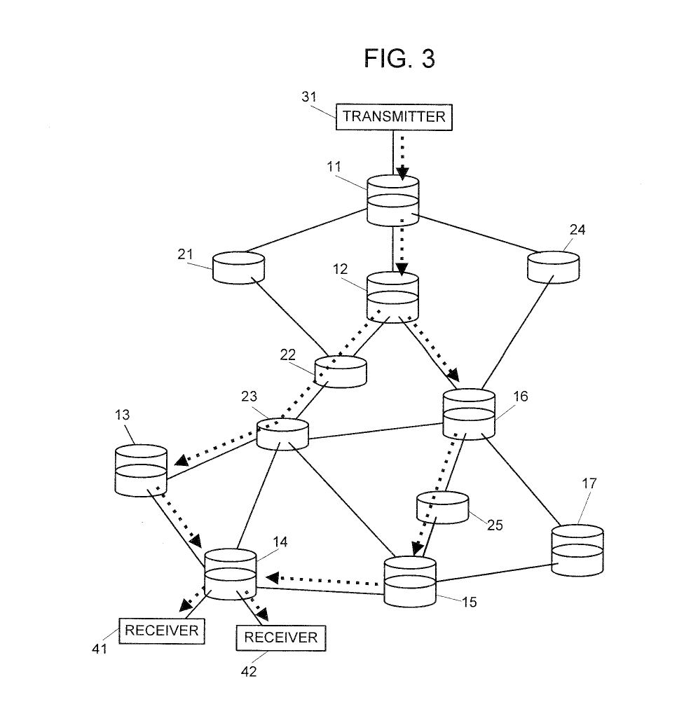

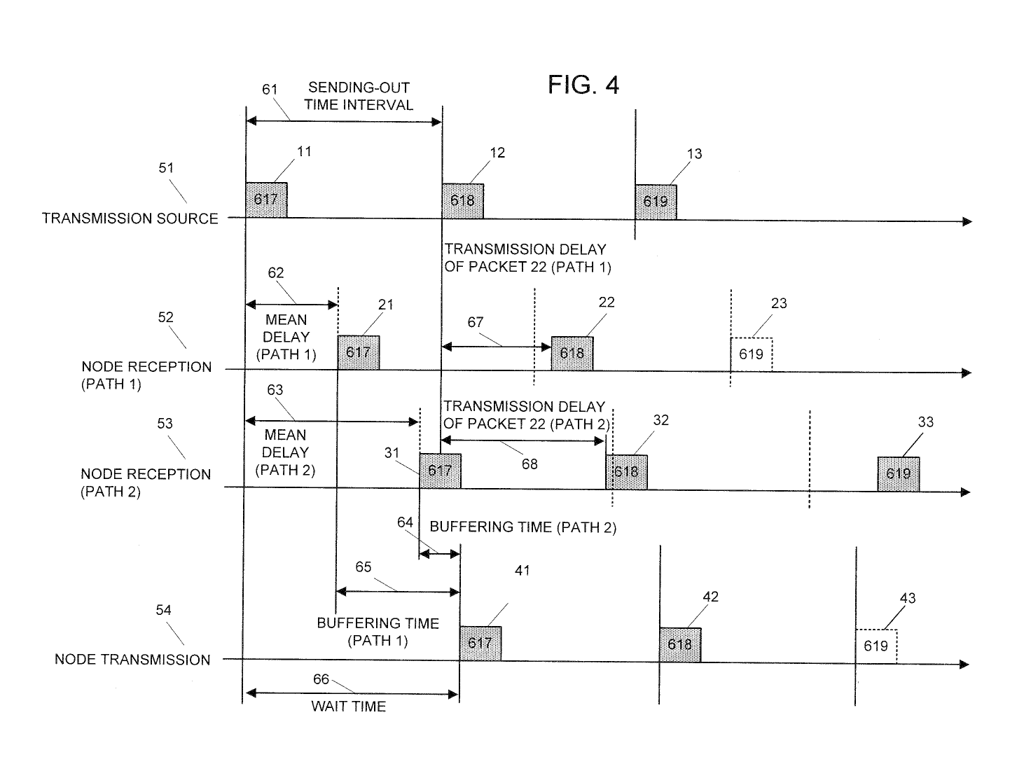

### DESCRIPTION OF NUMERALS

7, 7A, and 7B multicast node apparatuses (router apparatuses)
11 to 25 nodes
31 transmitter
41 to 46 receivers
111 to 11n statistics processing units
121 to 12n receiving buffers
131 wait time calculator
132 packet synchronizer
1321 path table
1322 stream number
1323 downstream pier
1324 upstream pier
141 packet receiver
1411 upstream pier management table
1412 pier
1413 an 1415 addresses
1414 and 1416 port numbers
142 packet transmitter
1421 downstream pier management table
1422 downstream pier
1423 an 1425 addresses
1424 and 1426 port numbers
143 path managing unit
144 real time clock
151 to 15m network interfaces
161 to 16p transmitting buffers
1711 wait time
1712 arrival rate
181 to 18n arrival rate measures
191 to 19n frequency distribution correspondence statistics processing units
1911 and 1921 transmission delays
1912 packet number
1922 accumulated packet number

### BEST MODE FOR CARRYING OUT THE INVENTION

Next, embodiments of the present invention will be explained in details by making a reference to the accompanied drawings.

FIG. 5 is a block diagram illustrating a functional configuration of the node apparatus in accordance with one example of the present invention.

In FIG. 5, a router apparatus 7 in accordance with one example of the present invention includes statistics processing units 111 to 11n, receiving buffers 121 to 12n, a wait time calculator 131, a packet synchronizer 132, transmitting buffers 161 to 16p, a packet receiver 141, a packet transmitter 142, a path managing unit 143, a real time clock 144, and network interfaces 151 to 15m.

Each of the network interfaces 151 to 15m makes a connection to a network existing outside the node apparatus.

The packet receiver 141 receives the packet via the network interfaces 151 to 15m, makes a reference to an upstream pier management table 1411, and determines a pier of the packet.

The packet of which the pier has been specified is sent to any receiving buffer, which corresponds to the upstream pier, out of the receiving buffers 121 to 12n.

The packet receiver 141 in the present invention treats the packet such as an RTP packet, in which the timestamp and the sequence number affixed at the time of sending-out the packet are included.

The so-called pier is a connection at a transport-layer protocol between the application-level multicast nodes.

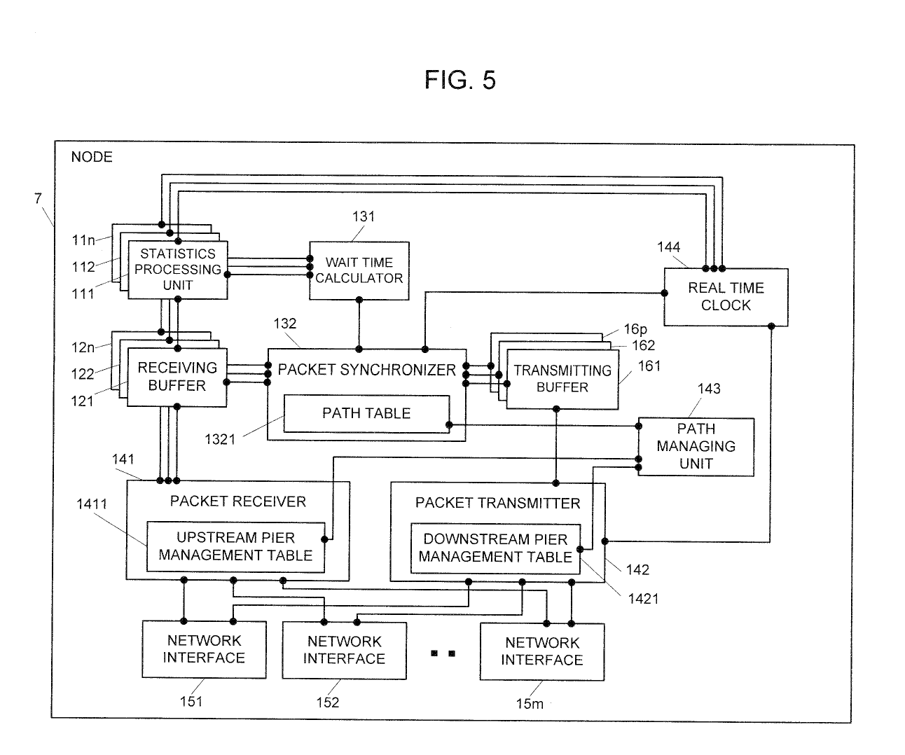

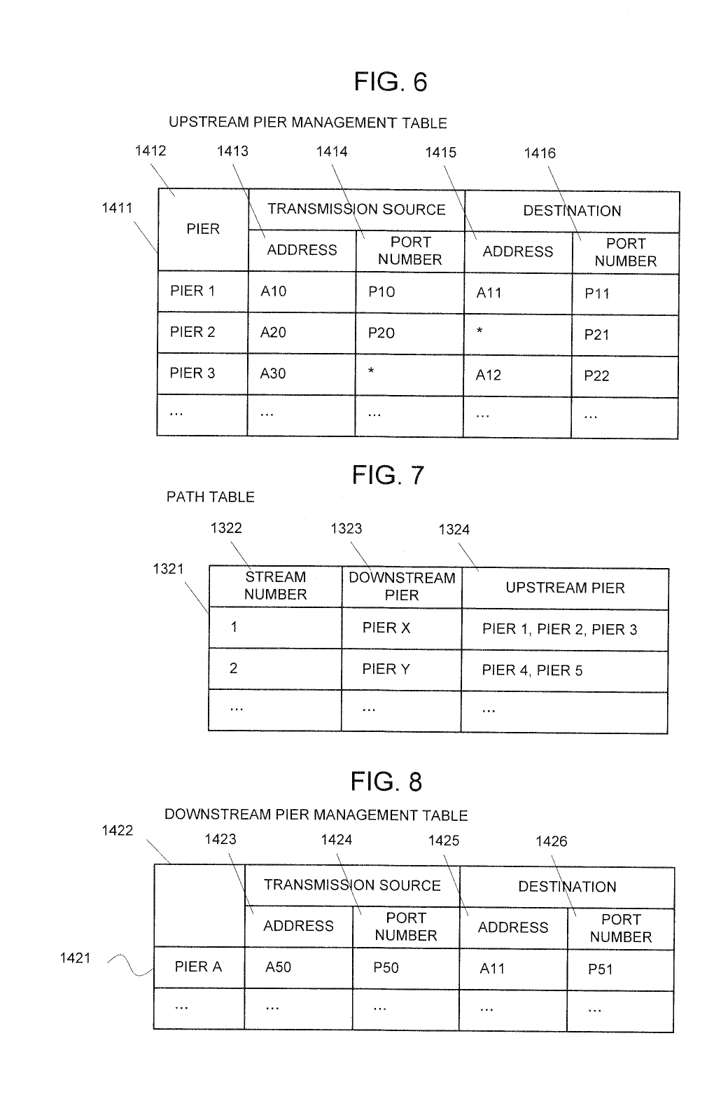

FIG. 6 is a view illustrating one example of a table (an upstream pier management table 1411) for specifying the corresponding upstream pier from the received packet in the case of having used a UDP (User Datagram Protocol) as a transport-layer protocol. Upon making a reference to FIG. 6, this upstream pier management table 1411 is configured of items of a pier 1412, a transmission source address 1413, a transmission source port number 1414, a destination address 1415, and a destination port number 1416.

The packet receiver 141 can determine that the packet is a packet received from a pier 1 by making a reference to this upstream pier management table 1411 in the case that the transmission source address, the transmission source port number, the destination address, and the destination port number of the received packet are A10, P10, A11, and P11, respectively,

For example, in a case where the destination address is signified with a wild card “*” like a pier 2 of FIG. 6, the packet receiver 141 assumes the packet having an optional destination address to be a corresponding packet. That is, the packet of which the transmission source address, the transmission source port number, and the destination port number are A20, P20, and P21, respectively, corresponds to a packet from the pier 2 irrespectively of the value of the destination address.

Herein, by employing the values that was included in an IP header and a UDP header, the upstream pier was specified; however any of the techniques, which enable the upstream pier to be specified from the received packet, may be employed. For example, it is also acceptable that a field into which a value for uniquely identifying the packet pier by pier is inserted is pre-arranged in any portion of the packet, and the upstream pier is specified with the value filed in the above field.

Upon making a reference to FIG. 5 once again, each of the statistics processing units 111 to 11n collects statistic information (a mean and a variance of the delays) relating to a packet reception quality per a pier unit when the received packet is filed into each of the receiving buffers 121 to 12n.

The wait time calculator 131 computes the wait time of the packet based upon information such as the delay and the packet loss rate collected in the statistics processing unit 111 to 11n, and sets the computed value to the packet synchronizer 132.

The packet synchronizer 132 merges the packet streams received from a plurality of the upstream paths. At this time, the packet synchronizer 132 makes a reference to a path table 1321, specifies a downstream pier, and sends the packet to any of the corresponding transmitting buffers 161 to 16p.

In FIG. 7, one example of the path table 1321 is shown. The path table 1321 includes a stream number 1322, a downstream pier 1323, and an upstream pier 1324 as an item.

For example, it follows
in the case where the upstream pier of the received packet is a pier 2, the downstream pier is a pier X, and
in the case where the upstream pier is a pier 4, the downstream pier is a pier Y.

Upon making a reference to FIG. 5 once again, the packet transmitter 142 sends out the packet, which are included in the transmitting buffers 161 to 16p, when the transmission schedule time comes.

The packet transmitter 142 makes a reference to a downstream pier management table 1421, and retrieves the transmission source address, the transmission source port number, the destination address, and the destination port number that are used in the downstream pier.

In FIG. 8, one example of the downstream pier management table 1421 is shown. It includes a transmission source address 1423, a transmission source port number 1424, a destination address 1425, and a destination port number 1426 that are used in a downstream pier 1422. The packet transmitter 142 sends out the packet via network interfaces 151 to 15m based upon these retrieved items of information. Further, the packet transmitter 142 may send out the packet not with the method of following the sending-out schedule time but with the method described below, in which
the sequence number of the packet just transmitted is pre-recorded,
in a case where the minimum sequence number, out of the sequence numbers of the packets that are included in the transmitting buffers, is a value next to the already-transmitted sequence number, the packet transmitter 142 sends out its packet, and
in a case where the minimum sequence number, out of the sequence numbers of the packets that are included in the transmitting buffers, is not a value next to the already-transmitted sequence number, the packet transmitter 142 sends out its packet if, notwithstanding waiting until the sending-out schedule time of the packet, the packet having a value next to the already-transmitted sequence number has not entered the transmitting buffer up to that time.

Upon making a reference to FIG. 5 once again, the path managing unit 143 manages information relating to the path, and sets appropriate values to each of the path table 1321, the upstream pier management table 1411, and the downstream pier management table 1421.

The setting of the path information to the path managing unit 143 may be made manually, or the setting may be made by the network managing terminal via the network.

The real time clock 144 supplies information of the current time responding to a request by each unit of the statistics processing units 111 to 11n, the packet synchronizer 132, and the packet transmitter 142.

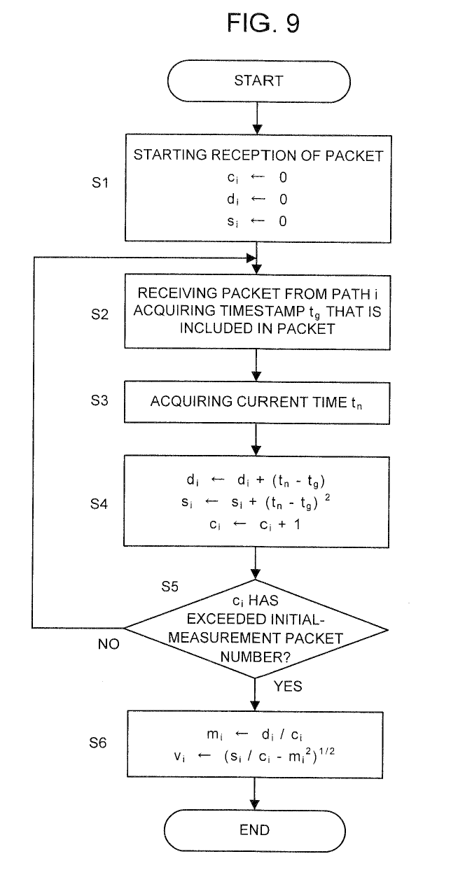

FIG. 9 is a flowchart for explaining an operation of the statistics processing unit 111 of one embodiment of the present invention. The operation of obtaining a mean and a variance of the delays by the statistics processing unit 11i of FIG. 5 will be explained by making a reference to FIG. 5 and FIG. 9.

At first, each of counters cᵢ, dᵢ, and sᵢ is pre-set equal to 0 (zero) (step S1).

The statistics processing unit waits for reception of the packet from a path i, makes a reference to the timestamp that is included in the received packet, and assumes its value to be tₛ (step S2).

A current time tₙ is acquired from the real time clock 144 (step S3).

A difference between the current time tₙ and a packet transmission time tₛ is computed and dᵢ is added to the obtained value. This dᵢ signifies a sum of values of the delays of respective packets. Further, the square of the difference is computed and sᵢ is added to the obtained value. This sᵢ signifies a sum of the values of the square of the delays of respective packets. Further, 1 (one) is added to cᵢ (step S4).

Next, it is investigated whether or not the value of cᵢ exceeds an initial-measurement packet number (step S5). The initial-measurement packet number is manually pre-given. In a case where the value of cᵢ does not exceed the initial-measurement packet number, the operation returns to the step S2.

In a case where the value of cᵢ has exceeded the initial-measurement packet number, the following computation is performed.

At first, a value mᵢ that is obtained by dividing dᵢ by cᵢ is found. This mᵢ signifies a mean of the transmission delays of respective packets.

Further, a square root vᵢ (=(sᵢ/cᵢ−mᵢ²)^{1/2}) of the value obtained by subtracting the square of mᵢ from the value obtained by dividing sᵢ by cᵢ is extracted. This vᵢ signifies a variance of the transmission delays of respective packets.

Herein, in the step 5, a loop process from the step S2 to the step S5 has been finished in a case where the number of the received packets has exceeded a predetermined value; however it may be judged that the loop process has been finished after a constant time has elapsed since starting a series of the processes.

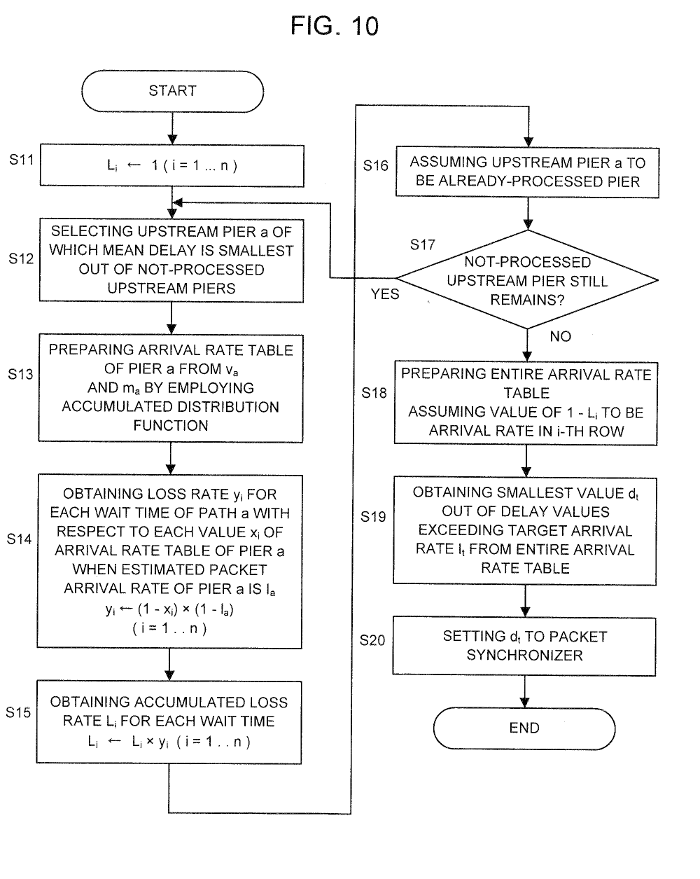

FIG. 10 is a flowchart for explaining an operation of the wait time calculator 131 of one embodiment of the present invention. Next, the operation of obtaining the wait time by the wait time calculator 131 of FIG. 5 will be explained by making a reference to FIG. 10.

At first, a value of 1 (one) is set to each Li (step S11). This i is an index indicative of a row of an arrival rate table of each pier.

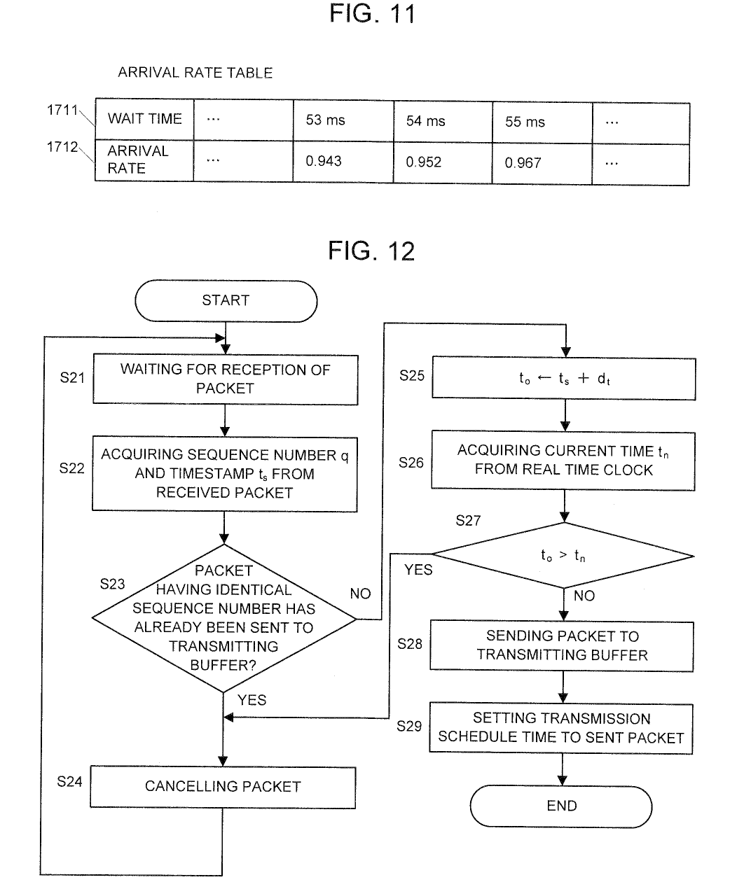

The arrival rate table will be explained by employing FIG. 11. The arrival rate table is a table indicative of a relation between a wait time 1711 (delay) and a probability (arrival rate) 1712 of the packet arriving within its wait time. The arrival rate table is filed/preserved, for example, in a memory inside the wait time calculator 131 as shown in FIG. 5.

Herein, a maximum value out of the row numbers of the arrival rate table of each pier is assumed to be n. At this point, the maximum value is unknown, so it is enough to arrange a sufficiently large value, which is assumed to be n.

Lᵢ is indicative of an accumulated loss rate in an i-th row of the arrival rate table for each path.

Upon making a reference to FIG. 10 once again, an upstream pier a of which the mean of the delays is smallest is selected from among the not-processed upstream piers (step S12).

Next, the wait time calculator prepares an arrival rate table of the pier a from a probability distribution function by employing a mean mₐ and a variance vₐ of the delays of the upstream pier a (step S13).

Herein, the probability distribution function having a normal distribution is employed; however the probability distribution function having a different distribution may be employed according to characteristics of the network.

Additionally, the arrival rate in the arrival rate table of FIG. 11 is prepared every transmission delay 1 ms; however the present invention is not limited to such a configuration. With an interval of the transmission delay in preparing the arrival rate table, for example, a manager may set an optional value.

In a step S14 of FIG. 10, the following process is performed for the arrival rate table prepared in the step S13.

Herein, it is assumed that a value of the i-th row of the arrival rate table is xᵢ, and an estimated packet arrival rate of the pier a is lₐ, respectively, and (1−xᵢ)×(1−lₐ) is obtained and the obtained value is assumed to be yᵢ.

yᵢ is computed over all rows of the arrival rate table.

The estimated packet arrival rate lₐ is a probability of the packet arriving without being lost in the path. For example, the estimated packet arrival rate of the path in which 5% of the packets are expected to be lost becomes 0.95.

With this estimated packet arrival rate,
the manager sets an optional value,
   or
it is set via a network by a network managing terminal etc.

yᵢ, which is a product of a probability at which, with the path a, the packet does not arrive within the wait time, and a probability at which the packet does not arrive at the node because the packet is lost in the path a, is indicative of a loss rate in the wait time of the i-th row of the path a.

Assuming that the wait time of the i-th row of the arrival rate table of the path a is 55 ms, yᵢ is indicative of a probability at which, with the path a, the packet does not arrive within 55 ms.

Next, Lᵢ is multiplied by a value of yᵢ over each row i of the arrival rate table of the path a (step S15).

This Lᵢ, which is an accumulated loss rate, is indicative of a probability at which the packet does not arrive within 55 ms through any of the paths processed up to this point if it is assumed that the wait time of the i-th row of the arrival rate table is 55 ms.

Next, it is assumed that the upstream pier a has already been processed (step S16), and it is investigated whether or not the other not-processed upstream pier still remains (step S17). In a case where the other not-processed upstream pier still remains, the operation returns to the step S12.

In a case where the process has been finished for all upstream piers, an entire arrival rate table is prepared by employing Lᵢ obtained in the computation performed up to this point.

At this time, it is assumed that 1−Lᵢ is an arrival rate in the i-th row of the entire arrival rate table (step S18).

Next, a minimum value dₜ, out of the delay values exceeding a target arrival rate lₜ, is obtained from the entire arrival rate table (step S19).

The obtained dₜ is set to the packet synchronizer (step S20).

FIG. 12 is a flowchart for explaining an operation of the packet synchronizer 132 of one embodiment of the present invention. The process of the packet synchronizer 132 will be explained by making a reference to FIG. 12.

The packet synchronizer waits for reception of the packet (step S21).

Upon receipt of the packet, the packet synchronizer acquires a sequence number q and a timestamp tₛ that are included in its packet (step S22).

The packet synchronizer scans the transmitting buffer, and confirms whether or not the packet having an identical sequence number exists (step S23).

In a case where the packet having an identical sequence number exists in the transmitting buffer, the above packet is canceled (step S24), and the operation returns to the step S21.

In a case where the packet having an identical sequence number does not exist in the transmitting buffer, tₛ+dₛ is calculated, and the obtained value is assumed to a transmission schedule time tₒ (step S25)

Next, the current time tₙ is acquired from the real time clock 144 (step S26).

It is investigated whether or not the current time tₙ is behind the transmission schedule time tₒ (step S27), and in a case where it is behind, the operation returns to the step S24.

In a case where the current time tₙ is not behind the transmission schedule time tₒ, the packet synchronizer sends the packet to the transmitting buffer (step S28), and sets the transmission schedule time of the sent packet to the transmitting buffer (step S29).

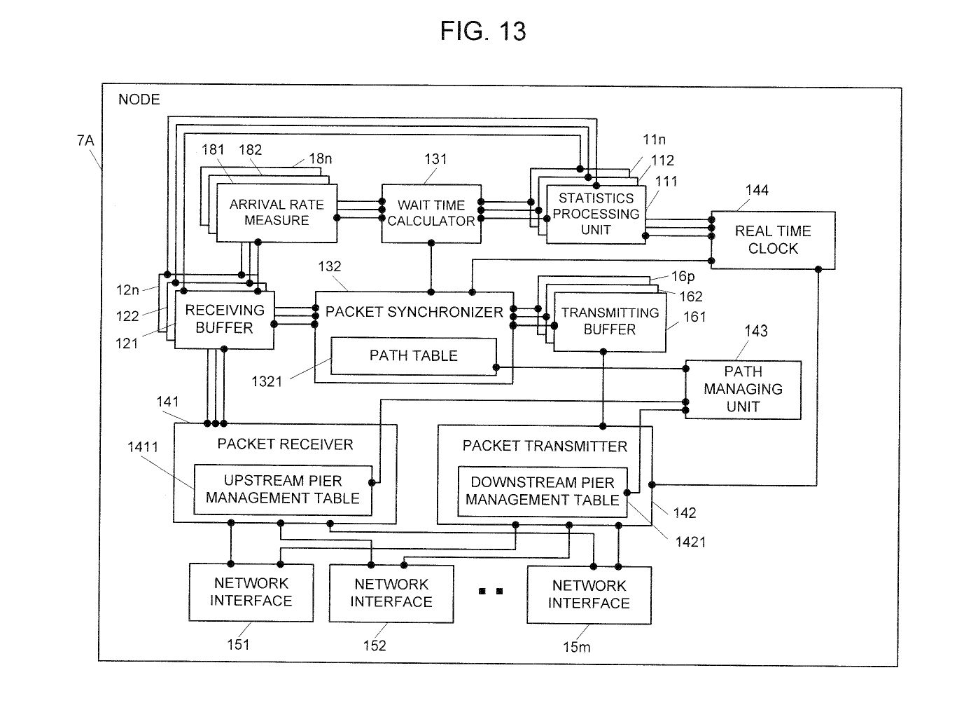

Next, a second embodiment of the present invention will be explained. FIG. 13 is a view illustrating a configuration of a node apparatus 7A of the second embodiment of the present invention. Upon making a reference to FIG. 13, the node apparatus 7A further includes arrival rate measures 181 to 18n in addition to the configuration of FIG. 5. Each of the arrival rate measures 181 to 18n investigates the sequence number of the packet that is filed into the receiving buffers 121 to 12n, and investigates an arrival rate of the packet per unit time. The investigated packet arrival rate is delivered to the packet synchronizer 132.

In the foregoing first embodiment shown in FIG. 5, it was necessary to pre-decide the value, which was estimated to be a packet arrival rate, at the moment of obtaining the wait time in the procedure shown in FIG. 10.

On the other hand, in the second embodiment of the present invention, each of the arrival rate measures 181 to 18n measures the actual packet loss rate path by path, thereby enabling more appropriate wait time responding to a fluctuation in a situation of the network to be obtained.

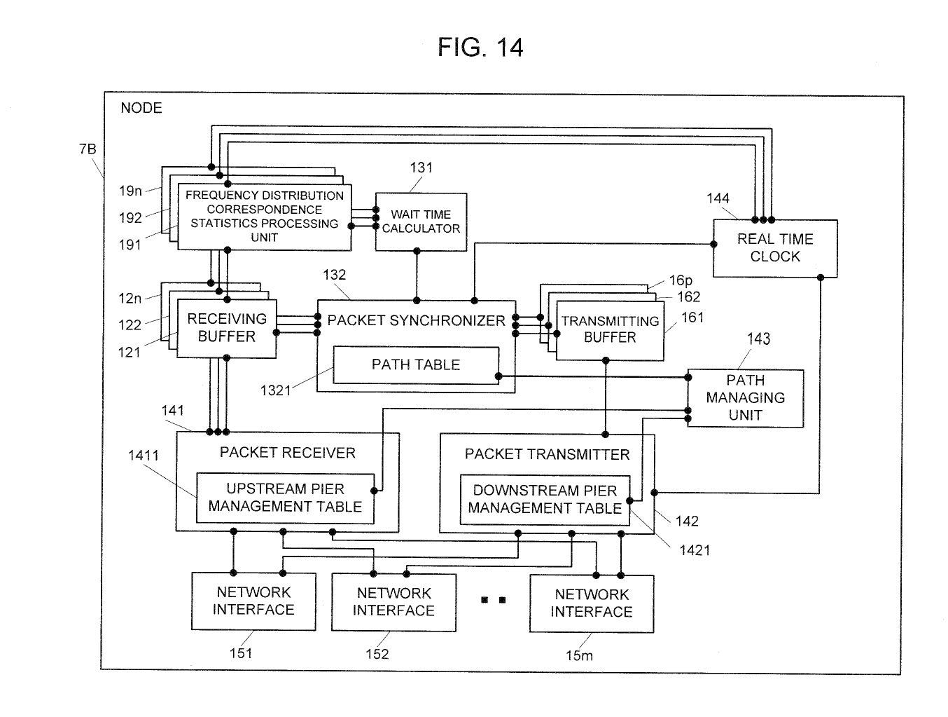

Next, a third embodiment of the present invention will be explained. FIG. 14 is a view illustrating a configuration of a node apparatus of the third embodiment of the present invention. Upon making a reference to FIG. 14, in the third embodiment of the present invention, a node apparatus 7B includes frequency distribution correspondence statistics processing units 191 to 19n. Each of the frequency distribution correspondence statistics processing units 191 to 19n subtracts the value of the timestamp, which has been acquired from the packet, from the current time, which has been acquired from the real time clock 144, for each of the packets received from the packet receiver 141, thereby to calculate a transmission delay of the packet.

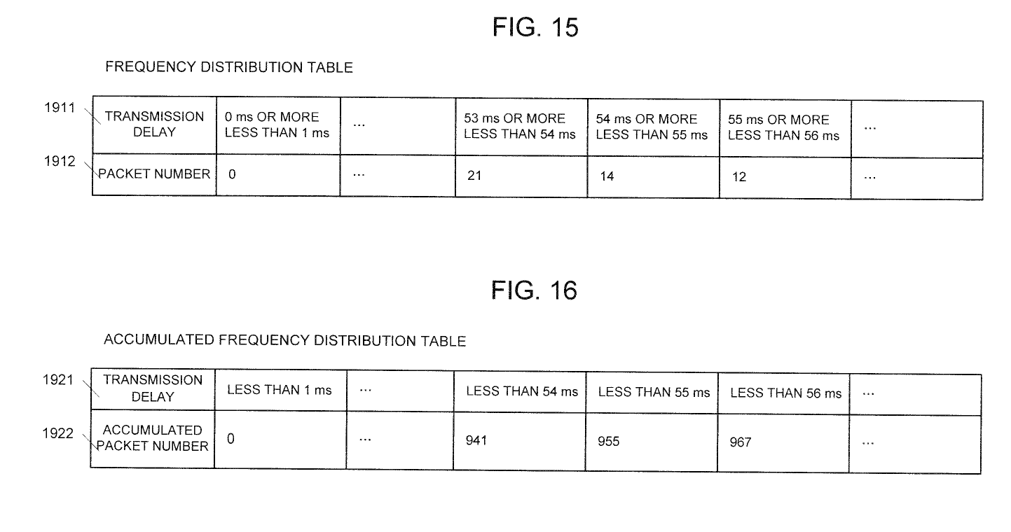

A frequency distribution table is prepared by collecting the packet number for each class width of the transmission delay sectioned for each constant space. An example of the frequency distribution table and an example of the accumulated frequency distribution table are shown in FIG. 15 and in FIG. 16, respectively. The number of the packets is recorded responding to each section of the transmission delay. In the frequency distribution table of FIG. 15 and in the accumulated frequency distribution table of FIG. 16, the width is 1 ms; however the manger may set an optional value hereto. Each of the frequency distribution correspondence statistics processing units 191 to 19n may include the frequency distribution table and the accumulated frequency distribution table, and the wait time calculator 131 may include them.

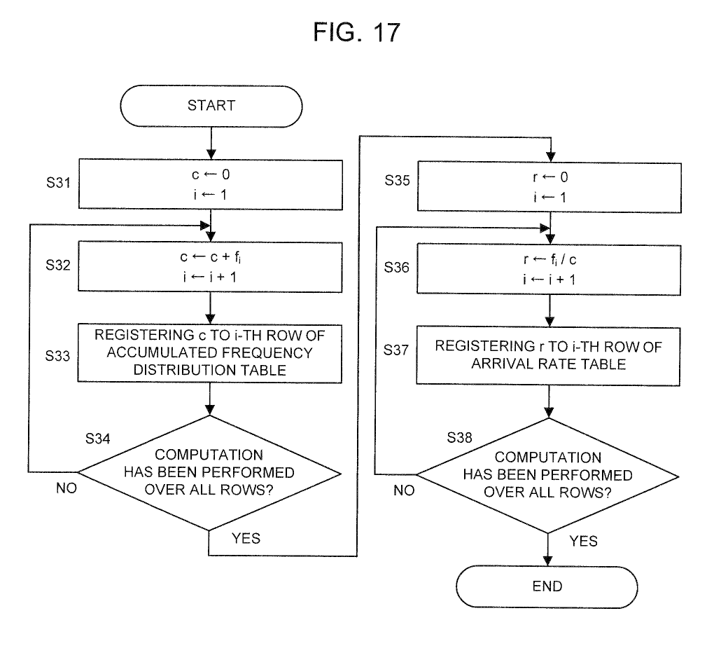

Next, a procedure of preparing the arrival rate table from the frequency distribution table in this embodiment will be explained by making a reference to a flowchart of FIG. 17. Additionally, the arrival rate table having the format explained by making a reference to FIG. 11 is employed.

At first, 0 (zero) is set to c, and 1 (one) to i, respectively (step S31). Herein, i is a variance indicative of a row in the frequency distribution table.

Next, a value of fᵢ is added to c. fᵢ is indicative of the packet number of the i-th row of the frequency distribution table. Next, 1 (one) is added to i (step S32)

c is registered to an entry of the accumulated packet number of the i-th row of the accumulated frequency distribution table (step S33). The accumulated frequency distribution table shown in FIG. 16 is employed.

Next, it is investigated whether the computation for all rows of the frequency distribution table has been finished, and if it has not finished yet, the operation returns to the step S32 (step S34).

In a case where the computation for all rows has been finished, the operation proceeds to a step S35. At this time point, a value of c is indicative of a sum of the packet numbers collected in the frequency distribution table.

Next, 0 (zero) is substituted into r, and 1 (one) into i, respectively (step S35).

Next, a value obtained by dividing fᵢ by c is substituted into r. Further, 1 (one) is added to i (step S36).

r is registered to an entry of the arrival rate of i-th row of the arrival rate table (step S37).

It is investigated whether the computation for all rows of the accumulated frequency distribution table (FIG. 16) has been finished, and if it has not been finished yet, the operation returns to step S36 (step S38).

In a case where the computation for all rows has been finished, the operation comes to an end.

The procedure of computing the wait time from the arrival rate table obtained herein is similar to that of the first embodiment of the present invention.

In the first embodiment explained by making a reference to FIG. 5, a lot of the actual operations have to be performed in obtaining the arrival rate table from the probability distribution function.

In this embodiment, the sole actual operation is division alone in the step S36 of FIG. 17 (fi/c), and other operation is configured of addition of integers alone. For this reason, an object can be realized with lower load as compared with the first embodiment.

The present invention is preferredly employed for a live video delivery employing in IP network.

Above, while the present invention was explained according to the above-mentioned examples thereof, the present invention is not limited to the configurations of the above-mentioned examples, and needless to say, the scope of the present invention includes various alterations to, and variations of these examples that those skilled in the art may readily carry out.

1-25. (canceled)

26. A node apparatus, characterized in comprising:
a network interface that makes a connection to a network existing outside the apparatus;
a packet receiver for receiving a packet via said network interface;
a statistics processing unit for collecting statistic information relating to said received packet;
a wait time calculator for deciding a wait time of said packet based upon said collected statistic information.

27. The node apparatus according to claim 26, characterized in that said packet receiver receives a multicast packet.

28. The node apparatus according to claim 26, characterized in that said statistics processing unit collects the statistic information reception path by reception path.

29. The node apparatus according to claim 26, characterized in that said statistics processing unit collects the statistic information relating to a delay of the packet.

30. The node apparatus according to claim 26, characterized in that said packet receiver receives the packet including a sequence number and a timestamp.

31. The node apparatus according to claim 30, characterized in including a packet synchronizer for making a reference to the sequence number of the packet received by said packet receiver, and filing the packet having a not-filed sequence number into a transmitting buffer.

32. The node apparatus according to claim 26, characterized in that said statistics processing unit obtains a mean of the delays of the packets.

33. The node apparatus according to claim 26, characterized in that said statistics processing unit obtains a variance of the delays of the packets.

34. The node apparatus according to claim 26, characterized in that said wait time calculator decides the wait time for each reception path of the packet by employing a probability distribution function.

35. The node apparatus according to claim 26, characterized in that said statistics processing unit decides the wait time by employing a frequency distribution relating to the delay of the packet.

36. The node apparatus according to claim 26, said node apparatus further comprising an arrival rate measure for measuring an arrival rate of the packet, characterized in that said wait time calculator decides the wait time by employing the arrival rate measured by said arrival rate measure.

37. The node apparatus according to claim 26, characterized in that said wait time calculator:
prepares an arrival rate table indicative of a relation between the wait time and the arrival rate based upon a probability distribution function that is obtained a mean and a variance of said delays of the packets in the reception path, and a pre-given loss rate for each path; and
obtains a minimum wait time that satisfies a target packet arrival rate by employing said arrival rate table.

38. A packet transfer method of sending out a received packet at a sending-out time, characterized in including the steps of:
receiving a packet;
collecting statistic information relating to said received packet; and
computing a wait time of said packet based upon said collected statistic information.

39. The packet transfer method according to claim 38, characterized in that said step of receiving the packet is a step of receiving a multicast packet.

40. The packet transfer method according to claim 38, characterized in that said step of collecting the statistic information is a step of collecting the statistic information reception path by reception path.

41. The packet transfer method according to claim 38, characterized in that that said step of collecting the statistic information is a step of collecting the statistic information relating to a delay of the packet.

42. The packet transfer method according to claim 38, characterized in that that said step of receiving the packet is a step of receiving the packet including a sequence number and a timestamp.

43. The packet transfer method according to claim 42, characterized in including a step of making a reference to the sequence number of the packet received in said step of receiving the packet, and sending out the packet having a not-sent sequence number at a sending-out time.

44. The packet transfer method according to claim 38, characterized in obtaining a mean of the delays of the packets in said step of collecting the statistic information.

45. The packet transfer method according to claim 38, characterized in obtaining a variance of the delays of the packets in said step of collecting the statistic information.

46. The packet transfer method according to claim 38, characterized in deciding the wait time for each reception path of the packet by employing a probability distribution function in said step of computing the wait time.

47. The packet transfer method according to claim 38, characterized in deciding the wait time by employing a frequency distribution relating to the delay of the packet in said step of computing the wait time.

48. The packet transfer method according to claim 38, said packet transfer method further including a step of measuring an arrival rate of the packet, characterized in that said step of computing the wait time is a step of deciding the wait time by employing the measured arrival rate.

49. The packet transfer method according to claim 38, characterized in, in said step of computing the wait time, preparing an arrival rate table indicative of a relation between the wait time and the arrival rate based upon a probability distribution function that is obtained a mean and a variance of said delays of the packets in the reception path, and a pre-given loss rate for each path, and obtaining a minimum wait time that satisfies a target packet backup rate (arrival rate) by employing said arrival rate table.

50. A program for a packet transfer, said program causing a computer to execute the processes of:
receiving a packet;
collecting statistic information relating to a delay value from said received packet reception path by reception path; and
computing a wait time of said packet based upon said collected statistic information.

51. The program according to claim 50, characterized in that said process of receiving the packet is a process of receiving a multicast packet.

52. The program according to claim 50, characterized in that said process of collecting the statistic information is a process of collecting the statistic information reception path by reception path.

53. The program according to claim 50, characterized in that that said process of collecting the statistic information is a process of collecting the statistic information relating to the delay of the packet.

54. The program according to claim 50, characterized in that that said process of receiving the packet is a process of receiving the packet including a sequence number and a timestamp.

55. The program according to claim 54, characterized in including a step of making a reference to the sequence number of the packet received in said process of receiving the packet, and sending out the packet having a not-sent sequence number at a sending-out time.

56. The program according to claim 54, characterized in that said process of collecting the statistic information includes a process of obtaining a mean of the delays of the packets.

57. The program according to claim 54, characterized in that said process of collecting the statistic information includes a process of obtaining a variance of the delays of the packets.

58. The program according to claim 54, characterized in that said process of computing the wait time includes a process of deciding the wait time by employing a probability distribution function for each reception path of the packet.

59. The program according to claim 50, characterized in that said process of computing the wait time includes a process of deciding the wait time by employing a frequency distribution relating to the delay of the packet.

60. The program according to claim 50, characterized in causing said computer to execute the processes of:
measuring an arrival rate of the packet; and
deciding the wait time by employing said measured arrival rate.

61. The program according to claim 50, characterized in causing said computer to execute the processes of:
preparing an arrival rate table indicative of a relation between the wait time and the arrival rate based upon a probability distribution function that is obtained a mean and a variance of said delays of the packets in the reception path, and a pre-given loss rate for each path; and
obtaining a minimum wait time that satisfies a target packet arrival rate by employing said arrival rate table.

62. A node apparatus having an application-level packet transfer function, characterized in comprising:
a network interface that makes a connection to a network existing outside said node apparatus;
a packet receiver for receiving a packet including timestamp information and sequence information attached at the time of sending out the packet via said network interface, making a reference to a table into which a correspondence of a pier, a transmission source, and destination information has been filed, specifying a corresponding upstream pier from the received packet based upon the transmission source and the destination information, and sending said received packet to a receiving buffer that corresponds to the specified upstream pier;
a statistics processing unit for collecting at least one item of information of a mean of delays, a variance of delays, a frequency distribution of delays, and a packet loss rate of the received packets for each pier unit;
a wait time calculator for computing a packet wait time based upon the information collected by said statistics processing unit; and
a packet synchronizer for, by making a reference to a table for managing a correspondence of an upstream pier and a downstream pier, specifying a downstream pier, which corresponds to said specified upstream pier, from the packets received from a plurality of upstream paths and filed into said receiving buffer, and filing the packet into the transmitting buffer that corresponds to said specified downstream pier.

63. The node apparatus according to claim 62, characterized in comprising:
a packet transmitter for, with a packet filed into said transmitting buffer, making a reference to the table into which a correspondence of the pier, the transmission source, and the destination information has been filed, and sending out said packet via a corresponding network interface based upon information of the transmission source and the destination that is used in the downstream pier; and
a path managing unit for managing contents of the tables of the packet receiver, the packet transmitter, and the packet synchronizer.

64. The node apparatus according to claim 62, characterized in that said wait time calculator prepares an arrival rate table indicative of a relation between the wait time and an arrival rate based upon a probability distribution function that is obtained a mean and a variance of said delays of the packets in the reception path, and a pre-given loss rate for each path, and obtains a minimum wait time that satisfies a target packet arrival rate by employing said arrival rate table.

65. The node apparatus according to claim 62, said node apparatus further comprising an arrival rate measure for measuring an arrival rate of the packet, characterized in that said wait time calculator decides the wait time by employing the arrival rate measured by said arrival rate measure.

66. A communication system, characterized in comprising:
a network:
a network interface that makes a connection to said network;
a packet receiver for receiving a packet via said network interface;
a statistics processing unit for collecting statistic information relating to said received packet; and
a wait time calculator for deciding a wait time of said packet based upon said collected statistic information.
